(19) United States
(12) Patent Application Publication
(10) Pub. No.: US 2023/0313534 A1
(43) Pub. Date: Oct. 5, 2023

(54) NOVEL INTELLIGENT ADJUSTABLE PASSIVE ROOF

(71) Applicant: TSINGHUA UNIVERSITY, Beijing (CN)

(72) Inventors: Borong LIN, Beijing (CN); Yifan WU, Beijing (CN); Hongli SUN, Beijing (CN); Mengfan DUAN, Beijing (CN)

(21) Appl. No.: 18/023,248

(22) PCT Filed: Mar. 23, 2021
(86) PCT No.: PCT/CN2021/082317

§ 371 Date: Feb. 24, 2023

(30) Foreign Application Priority Data
Aug. 31, 2020 (CN) 202010894314.6

(51) Int. Cl. E04D 11/02; B32B 3/08; B32B 7/05; B32B 15/20; B32B 15/04; B32B 7/02

(52) U.S. Cl. CPC E04D 11/02; B32B 3/08; B32B 7/05; B32B 15/20; B32B 15/043; B32B 7/02; B32B 2419/06; B32B 2307/728; B32B 2307/726; B32B 2307/73; B32B 2255/06; B32B 2255/20; B32B 2307/7265

(57) ABSTRACT

Disclosed is a novel intelligent adjustable passive roof, comprising an inner roof layer, an air layer, a thermal diode of jumping droplet materials and an outer roof layer which are sequentially arranged from bottom to top. The thermal diode of jumping droplet materials comprises a super-hydrophilic layer, a super-hydrophilic layer surface liquid-absorbing core and a super-hydrophobic layer which are sequentially arranged from bottom to top, and the super-hydrophilic layer is separated from the super-hydrophobic layer by gasket materials on left and right sides to form an intermediate air interlayer. By means of passive heat transfer control of the super-hydrophilic layer and the super-hydrophobic layer in the thermal diode of jumping droplet materials, a novel intelligent adjustable passive roof, which is driven passively by indoor and outdoor temperatures for “heat extraction/heat insulation,” does not need to be manually cleaned, and can be embedded into a building enclosure structure, is formed.

### CROSS-REFERENCE TO RELATED APPLICATION

This patent application claims the benefit and priority of Chinese Patent Application No. 202010894314.6, filed with the China National Intellectual Property Administration on Aug. 31, 2020, the disclosure of which is incorporated by reference herein in its entirety as part of the present application.

### TECHNICAL FIELD

The present disclosure relates to the technical field of architectural engineering, and in particular relates to a novel intelligent adjustable passive roof.

### BACKGROUND

For a long time, the building enclosure structure is mainly designed for static thermal insulation. The whole heat resistance of the enclosure structure is increased in a form of adding thermal insulation materials with high heat resistance, thus reducing the heat transfer between indoor and outdoor. Such enclosure structures are suitable for thermal insulation in winter in severe cold and cold areas, but are not suitable for the areas where heat prevention is the main concern throughout the year and for buildings where heat extraction is the main concern. For such areas and buildings, indoor heat is hard to be discharged outwards in time through the enclosure structure due to static high heat resistance, and only be discharged by active equipment, which virtually increases the cooling energy consumption.

Taking the area with hot summer and warm winter as an example, its climate is characterized by long summer without winter, with the day with average daily temperature≥25° C. of 100 to 200 days, and the average temperature in the coldest month of higher than 10° C., the climate characteristics of this area determine that buildings should be mainly protected from heat throughout the year and have no heating demand. Moreover, data rooms and other high heat production places, due to the excessive heat production of their own internal heat sources, also determine that the buildings should focus on heat extraction throughout the year and have no heating demand.

Whether the area with hot summer and warm winter needing heat prevention throughout the year determined by climatic conditions, or data rooms and other places needing heat extraction throughout the year with their own internal heat sources, the building enclosure structure with static high heat resistance cannot meet the heat extraction requirements, and an ideal enclosure form for such buildings should be intelligently adjustable: when the indoor temperature is higher than the outdoor temperature, the heat resistance of the enclosure structure can be reduced to discharge the heat to the outdoor in time; and when the outdoor temperature is higher than the indoor temperature, the heat resistance of the enclosure structure can be increased to reduce the heat transfer from outdoor to indoor. Such enclosure structures can satisfy the actual demands of the areas where heat prevention is the main concern throughout the year and the buildings where heat extraction is the main concern.

In the prior art most similar to the present disclosure, a radiation cooling metamaterial layer is combined with a wall body or a roof to form a building enclosure structure for passive cooling. A hollow radiation cooling passive structure for a building external wall or a roof (publication number: CN108222367A) is proposed by Xu Shaoyu et al of Shenzhen Radi-cool Advanced Energy Technologies Co., Ltd, the structural components of the device and their relationships are described as follows:

FIG. 1 and FIG. 2 respectively show a schematic diagram of an overall structure and a schematic diagram of the cross section of a hollow radiation-cooling passive structure for a building external wall or a roof. The hollow radiation-cooling passive structure for a building external wall or a roof comprises an air chamber 60 consisting of an outer layer plate 10, an inner layer plate 20, an upper top plate 30, a lower bottom plate 40, and two side plates 50. The upper top plate 30 and the lower bottom plate 40 are respectively fixed to the upper end and the lower end of the outer layer plate 10, the outer layer plate 10 and the inner layer plate 20 are arranged on the lower bottom plate 40 in parallel; the upper top plate 30 is covered on the outer layer plate 10 and the inner layer plate 20, the two side plates 50 are respectively arranged at both sides of the outer layer plate 10, and the two side plates 50 are connected to the upper top plate 30, the lower bottom plate 40 and the inner layer plate 20. An air inlet 210 is arranged between the inner layer plate 20 and the upper top plate 30, and an air outlet 220 is arranged between the inner layer plate 20 and the lower bottom plate 40. The outermost surface of the outer layer plate 10 is provided with a radiation cooling metamaterial layer 70. The radiation cooling metamaterial layer 70 is a core cooling component for the heat extraction roof. The existing roof technology mainly focuses on static heat insulation, which refers to provide a thermal insulation layer inside or outside the structural layer to increase the heat resistance of the roof, thus reducing the heat transfer between the indoor and outdoor. The static heat insulation characteristic of the traditional roof determines that the heat resistance of the roof is not affected by seasonal change and other factors, and the heat resistance of the roof cannot be flexibly adjusted according to indoor and outdoor temperatures.

However, the hollow radiation cooling passive structure for the building external wall or roof described above has changed the heat insulation characteristic of the traditional roof. By utilizing the thermal radiation effect of the radiation-cooling metamaterial layer on the roof surface, the heat insulation characteristic of the traditional roof is changed as the heat extraction characteristic, and the heat is transferred to a cooler outer space environment by means of sky cooling radiation. In accordance with the radiation cooling metamaterial layer, a part of visible light with short wavelength is reflected through a silver-plated film with high reflectivity, and another part of infrared light with long wavelength is absorbed through the metamaterial with high absorptivity, and then the infrared window of the atmosphere with the wavelength of 8 μm to 13 μm is configured to directly radiate infrared light into the outer space through the atmosphere, thus forming a roof for continuous heat extraction.

Based on the principle introduced above, there are the following disadvantages in the prior art:
1. Whether the traditional heat insulation roof with a thermal insulation layer or a heat extraction roof formed by using the radiation cooling metamaterial layer, the heat resistance of the roof is non-adjustable and can only satisfy the heat insulation mode or heat extraction mode singularly, and the roof cannot change with indoor and outdoor temperatures. For the traditional heat insulation roof with the thermal insulation layer, when the indoor temperature is higher than the outdoor temperature due to the non-adjustable high heat resistance of the roof, the heat cannot be discharged in time. For the roof formed by using the radiation cooling metamaterial layer, the structure is in continuous heat extraction at a fixed value and is also not intelligently adjustable, and has no function of heat insulation. If the indoor temperature is already low, the roof is still in heat extraction in one way by radiation, which is not affected by the indoor and outdoor temperature changes, and there is a risk that the temperature in the room is too low due to low indoor temperature.
2. For the heat extraction roof, the cooling principle of this technology determines that the radiation cooling metamaterial layer must be located at the outermost side of the building enclosure structure without being sheltered. However, during actual use, dew, rain, dust and other phenomena often occur, and there is a risk that extreme weather conditions such as hailstone may damage the surface of metamaterial layer, leading to the reduction of the actual passive cooling effect and poor technical feasibility. The user needs to maintain and clean the roof regularly, but the metamaterial layer located on the roof or the outer surface of the wall is inconvenient to maintain and clean, and then the passive advantage of the technology is reduced.

For the heat extraction roof, this technology has the problem of light pollution due to the high reflection mode for short-wave visible light.

### SUMMARY

For the defects in the prior art, an objective of the present disclosure is to provide a novel intelligent adjustable passive roof. By means of passive heat transfer control of the super-hydrophilic layer and the super-hydrophobic layer in the thermal diode of jumping droplet materials, a novel intelligent adjustable passive roof which is driven passively by indoor and outdoor temperatures for “heat extraction/heat insulation”, does not need to be manually cleaned and can be embedded into a building enclosure structure is formed.

The technical objective of the present disclosure is achieved through the following technical solutions: a novel intelligent adjustable passive roof comprises an inner roof layer, an air layer, a thermal diode of jumping droplet materials and an outer roof layer which are sequentially arranged from bottom to top. The thermal diode of jumping droplet materials comprises a super-hydrophilic layer, a super-hydrophilic layer surface liquid-absorbing core and a super-hydrophobic layer which are sequentially arranged from bottom to top, and the super-hydrophilic layer is separated from the super-hydrophobic layer by gasket materials on left and right sides to form an intermediate air interlayer.

Preferably, the inner roof layer comprises a structural layer, a slope making layer and a leveling layer which are sequentially from bottom to top, and both sides of the inner roof layer are provided with air passages communicating with the air layer.

Preferably, the outer roof layer comprises a binding layer, a waterproof layer and a protective layer which are sequentially arranged from bottom to top.

Preferably, an internal cycle working fluid in the air interlayer is deionized water.

Preferably, the super-hydrophilic layer and the super-hydrophobic layer are both made of copper plates. The surfaces of the super-hydrophilic layer and the super-hydrophobic layer are nano-coated with silver nitrate solution, are plated using hydrophilic and hydrophobic agents, respectively, and then are rinsed and dried to form the final super-hydrophilic layer and super-hydrophobic layer.

Preferably, the gasket material is made of polytetrafluoroethylene.

Compared with the prior art, the present disclosure has the following beneficial technical effects.
1. The novel intelligent adjustable passive roof has the advantages that the indoor heat extraction amount is subjected to self-switching control of the indoor and outdoor temperature difference, is intelligent and adjustable; and the continuous heat extraction is not at a fixed value, and is controlled by the fluctuation of the indoor and outdoor temperatures. When the outdoor temperature is lower than the indoor temperature, the air layer is combined with the thermal diode for one-way rapid heat extraction, the heat conductivity coefficient is high, and the heat extraction capacity is strong. When the outdoor temperature is higher than the indoor temperature, the thermal diode is configured for rapid heat insulation, the heat conductivity coefficient is small, and the heat insulation capacity is strong. The indoor temperature fluctuates with the outdoor temperature, so there is no risk of indoor overheating or supercooling. The reasonable indoor temperature change range can reduce the indoor cooling load, and then reduce the annual cooling energy consumption. The passive roof can also be used in cooperative with a cold supply system so as to achieve better actual use effect.
2. The novel intelligent adjustable passive roof is firm and stable. The thermal diode of the jumping droplet materials is placed inside the protective layer of the roof structure and thus cannot be affected by dew, rain, dust and other phenomena during actual use, and can also be prevented from the damage risk of extreme weather conditions such as hailstone to the components. The user has no need to maintain and clean the roof excessively, the use is convenient, the technical feasibility is strong, and the roof has the potential to form assembly-type integration of the building enclosure structure.
3. The novel intelligent adjustable passive roof provided by the present disclosure has no problem of light pollution.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an overall structure of a hollow radiation cooling passive structure for a building external wall or a roof in the patent in background art;

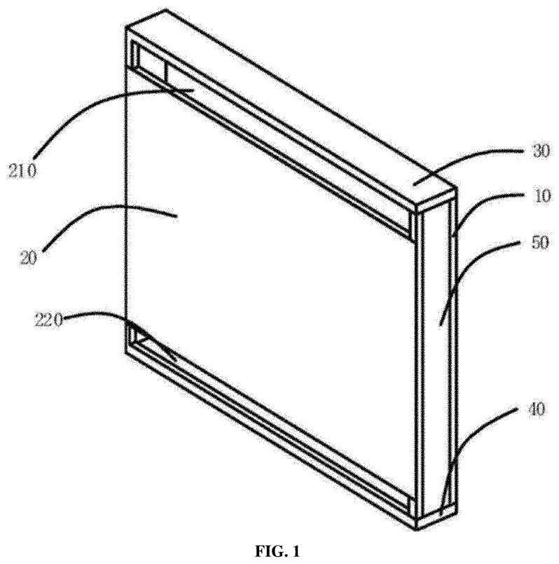

FIG. 2 is a schematic diagram of the cross section of a hollow radiation cooling passive structure for a building external wall or a roof in the patent in background art;

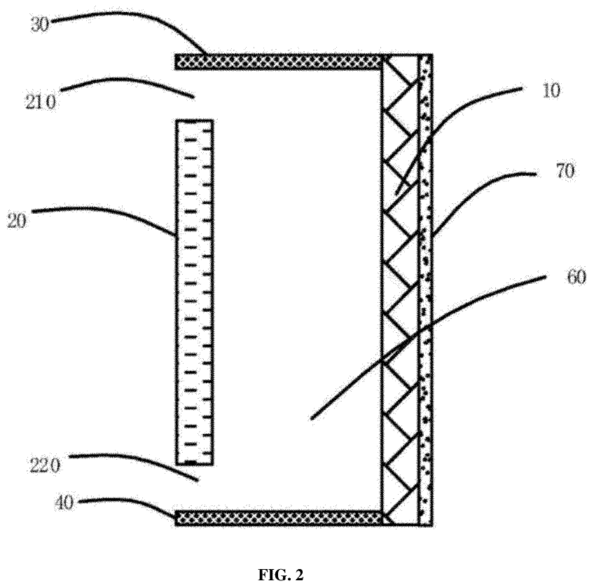

FIG. 3 is a structural configuration of a novel intelligent adjustable passive roof in accordance with the present disclosure;

FIG. 4 is a schematic diagram illustrating heat extraction process of a novel intelligent adjustable passive roof in accordance with the present disclosure;

FIG. 5 is a schematic diagram illustrating heat insulation process of a novel intelligent adjustable passive roof in accordance with the present disclosure.

In the drawings: 10—outer layer plate; 21—inner layer plate; 30—upper top plate; 40—lower bottom plate; 50—side plate; 60—air chamber; 70—radiation cooling metamaterial layer; 210—air inlet; 220—air outlet; 1—inner roof layer; 11—structural layer; 12—slope making layer; 13—leveling layer; 14—air passage; 2—air layer; 3—Thermal diode of jumping droplet materials; 31—super-hydrophilic layer; 32—super-hydrophilic layer surface liquid-absorbing core; 33—gasket material; 34—air interlayer; 35—super-hydrophobic layer; 4—outer roof layer; 41—binding layer; 42—waterproof layer; 43—protective layer.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a novel intelligent adjustable passive roof to solve the problem in the prior art.

To make the objectives, features and advantages of the present disclosure more apparently and understandably, the following further describes the present disclosure in detail with reference to the accompanying drawings and specific embodiments.

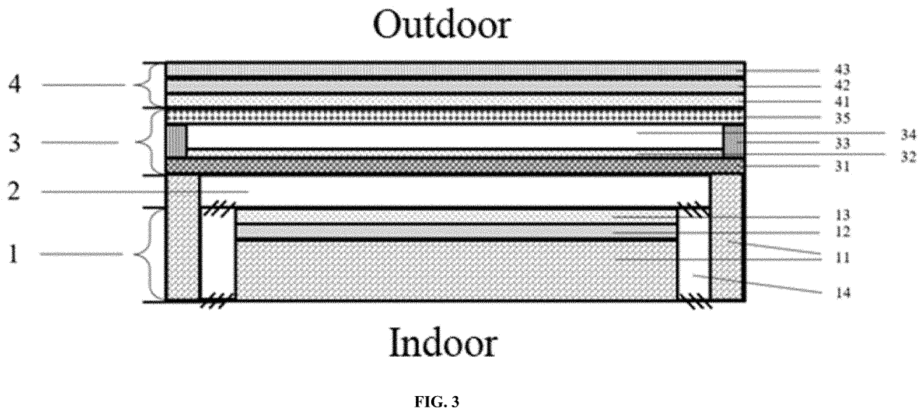

The novel intelligent adjustable passive roof in the embodiment, as shown in FIG. 3, comprises an inner roof layer 1, an air layer 2, a thermal diode of jumping droplet materials and an outer roof layer 4 which are sequentially arranged from bottom to top, where specific materials for the inner roof layer and the outer roof layer are not limited. The inner roof layer 1 comprises a structural layer 11, a slope making layer 12 and a leveling layer 13 which are sequentially arranged from bottom to top, and both sides of the inner roof layer 1 are provided with air passages 14 communicating with the air layer 2. The thermal diode of jumping droplet materials 3 comprises a super-hydrophilic layer 31, a super-hydrophilic layer surface liquid-absorbing core 32 and a super-hydrophobic layer 35 which are sequentially arranged from bottom to top; and the super-hydrophilic layer 31 is separated from the super-hydrophobic layer 35 by gasket materials 33 on left and right sides to form an intermediate air interlayer 34. The outer roof layer 4 comprises a binding layer 41, a waterproof layer 42 and a protective layer 43 which are sequentially arranged from bottom to top.

In the embodiment, an internal cycle working fluid in the air interlayer may employ deionized water 36. The super-hydrophilic layer 31 and the super-hydrophobic layer 35 may both be made of copper plates, the surfaces of the super-hydrophilic layer and the super-hydrophobic layer are nano-coated with silver nitrate solution, and are plated using a hydrophilic agent (such as CH₂Cl₂ mixed with a small amount of HS(CH₂)₁₁OH), a hydrophobic agent (such as CH₂Cl₂ mixed with a small amount of CF₃(CF₂)₇CH₂CH₂SH), and then are rinsed and dried to form the final super-hydrophilic layer 31 and super-hydrophobic layer 35. The gasket material 33 may be made of polytetrafluoroethylene with low heat conductivity coefficient, thus preventing “heat bridge” phenomenon. Related research on the thermal diode of jumping droplet materials 3 shows that at the room temperature, the forward heat conductivity coefficient (i.e., indoor to outdoor heat transfer) of the thermal diode of jumping droplet materials 3 is about 10 W/(m·K), and the reverse heat conductivity coefficient (i.e., outdoor to indoor heat transfer) is about 0.06 W/(m·K), and the forward and reverse heat transfer capacities have a great difference. There is a good application prospect of combining the thermal diode of jumping droplet materials with the building enclosure structure to form a novel roof with passive “heat extraction/heat insulation”, and the novel roof is suitable for the areas where heat prevention is mainly concerned throughout the year and the buildings where heat extraction is mainly concerned.

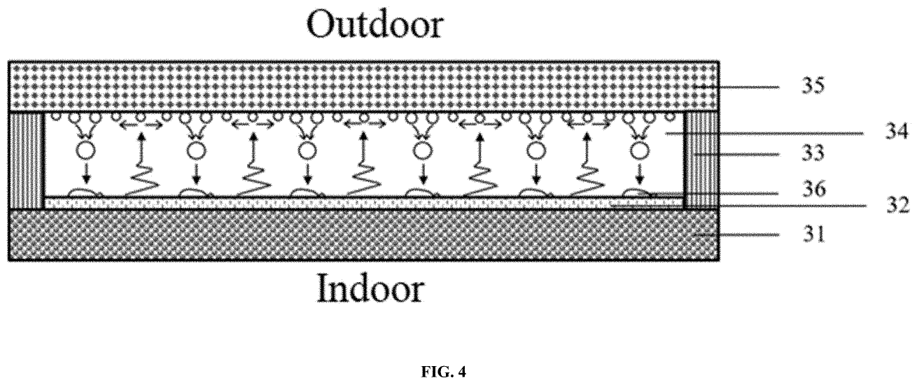

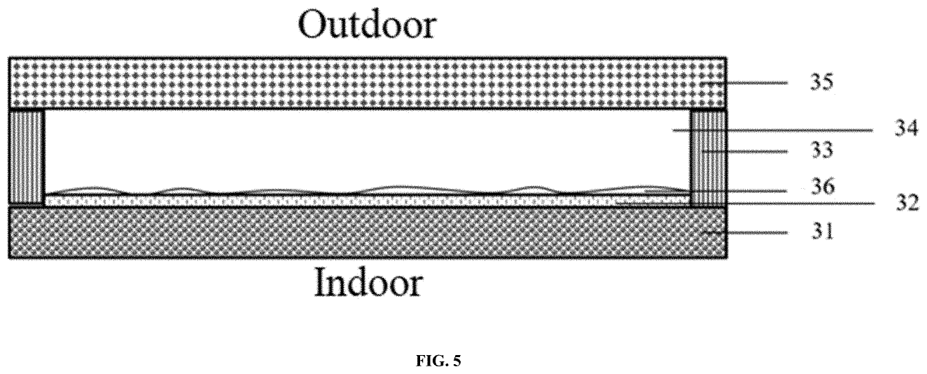

In accordance with the technical solution of the present disclosure, the heat extraction/heat insulation mode of the novel intelligent adjustable passive roof is controlled by combining the thermal diode of jumping droplet materials 3 with the air layer 2. The heat extraction mode and the heat insulation mode of the roof are both autonomously driven and controlled by the indoor and outdoor temperatures. FIG. 4 is a structure diagram of a thermal diode of jumping droplet materials 3 under an indoor to outdoor heat extraction mode, and FIG. 5 is a structure diagram of a thermal diode of jumping droplet materials 3 under an indoor to outdoor heat insulation mode.

The heat extraction mode is as follows: when the indoor temperature is higher than the outdoor temperature, the indoor hot air rises to enter the air layer 2 through the air passages 14 in the inner roof layer 1, the heat is transferred to the super-hydrophilic layer 31 at the bottom of the thermal diode of jumping droplet materials 3 by means of natural-convection heat transfer. Through the arrangement of the air layer 2, the hot air may directly exchange heat with the thermal diode of jumping droplet materials 3 by means of convection heat transfer in the heat extraction mode, the heat accumulation effect of the structural layer 11 in the inner roof layer 1 can be reduced to the greatest extent, thus discharging heat to the outdoor more rapidly.

Due to the fact that the super-hydrophilic layer 31 at the bottom of the thermal diode of jumping droplet materials 3 is heated, the deionized water 36 in the super-hydrophilic layer surface liquid-absorbing core 32 undergoes a phase change process when heated and absorbs heat by evaporation; the hot steam rises and encounters the cooler super-hydrophobic layer 35 above the thermal diode of jumping droplet materials 3, the phase change process occurs again on the surface of the super-hydrophobic layer 35, the heat is released by condensation to transfer the heat to the outer roof layer 4, and then the heat is transferred to the cooler outdoor. Meanwhile, due to the surface characteristics of the super-hydrophobic layer, the condensed deionized water 36 undergoes droplet aggregation on the surface of the super-hydrophobic layer 35, small droplets spontaneously aggregate to form large droplets, and the overall surface area of the droplets decreases. When the energy obtained by reducing the surface area is greater than the small adsorption force on the super-hydrophobic surface, the droplets may jump autonomously to leave the super-hydrophobic layer 35. With the help of the jumping phenomenon and gravity, the droplets pass through the air interlayer 34 and return to the lower super-hydrophilic layer 31 to complete the whole circulation process and to conduct the next indoor heat extraction process, as shown in FIG. 4.

The heat insulation mode is as follows: when the outdoor temperature is higher than the indoor temperature, the heat of the outdoor temperature is transferred to the super-hydrophobic layer 35 at the top of the thermal diode of jumping droplet materials. However, due to the fact that the characteristics of the thermal diode of jumping droplet materials 3 determine that the deionized water 36 infiltrates into the super-hydrophilic layer surface liquid-absorbing core 32, the phase change heat transfer process cannot occur. Only a small amount of heat can be transferred through the gasket materials 33 and the air interlayer 34 to play a role of heat insulation from indoor to outdoor, as shown in FIG. 5.

Taking the area with hot summer and warm winter without heating supply throughout the year as an example, the outdoor temperature in this area is mainly around 25-35° C. in summer. When the outdoor temperature is high during the day, the outdoor temperature is higher than the indoor temperature at the moment, i.e., the temperature of the outer roof layer 4 is higher than the temperature of the inner air layer 2 of the roof. According to the characteristics of the thermal diode of jumping droplet materials 3, the deionized water 36 infiltrates into the super-hydrophilic layer surface liquid-absorbing core 32, and the roof plays a role of heat insulation, and reduces the heat transfer from outdoor to indoor compared with the traditional roof. When the outdoor temperature begins to gradually decrease to be lower than the indoor temperature at night, the temperature of the inner air layer 2 of the roof is higher than that of the outer roof layer 4 at the moment. According to the characteristics of the thermal diode of jumping droplet materials 3, a phase change heat transfer process occurs, and the roof is automatically switched to the heat extraction mode, the heat is rapidly discharged to the outdoor through the passive roof, and the indoor temperature is kept relatively appropriate. When the outdoor temperature begins to gradually rise during the day to be higher than the indoor temperature again, the roof is automatically switched to the heat insulation mode, and so on. Therefore, the indoor cold load in the whole period is reduced, and then the cooling energy consumption is reduced.

Several examples are used for illustration of the principles and implementation methods of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. An intelligent adjustable passive roof, comprising an inner roof layer, an air layer, a thermal diode of jumping droplet materials and an outer roof layer which are sequentially arranged from bottom to top, wherein the thermal diode of jumping droplet materials comprises a super-hydrophilic layer, a super-hydrophilic layer surface liquid-absorbing core and a super-hydrophobic layer which are sequentially arranged from bottom to top; and the super-hydrophilic layer is separated from the super-hydrophobic layer by gasket materials on left and right sides to form an intermediate air interlayer.

2. The intelligent adjustable passive roof according to claim 1, wherein the inner roof layer comprises a structural layer, a slope making layer and a leveling layer which are sequentially from bottom to top, and both sides of the inner roof layer are provided with air passages communicating with the air layer.

3. The intelligent adjustable passive roof according to claim 1, wherein the outer roof layer comprises a binding layer, a waterproof layer and a protective layer which are sequentially arranged from bottom to top.

4. The intelligent adjustable passive roof according to claim 3, wherein an internal cycle working fluid in the air interlayer is deionized water.

5. The intelligent adjustable passive roof according to claim 1, wherein the super-hydrophilic layer and the super-hydrophobic layer are both made of copper plates, the surfaces of the super-hydrophilic layer and the super-hydrophobic layer are nano-coated with silver nitrate solution, are plated using hydrophilic and hydrophobic agents, respectively, and then are rinsed and dried to form the final super-hydrophilic layer and super-hydrophobic layer.

6. The intelligent adjustable passive roof according to claim 1, wherein the gasket material is made of polytetrafluoroethylene.
